(19) United States
(12) Patent Application Publication
(10) Pub. No.: US 2009/0230757 A1
(43) Pub. Date: Sep. 17, 2009

(54) WHEEL BALANCING DEVICE

(75) Inventor: Pravuth Chancharoen, Samutprakarn (TH)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: P.C. Products International Co., Ltd., Samutprakarn (TH)

(21) Appl. No.: 12/411,529

(22) Filed: Mar. 26, 2009

Related U.S. Application Data
(63) Continuation-in-part of application No. 11/898,684, filed on Sep. 14, 2007, now abandoned.

(30) Foreign Application Priority Data
Oct. 13, 2006 (TH) 0603001667

(51) Int. Cl. B60B 19/00

(52) U.S. Cl. 301/5.21

(57) ABSTRACT

A wheel balancing device of this invention comprising a wheel balancing body having a wheel rim engaging bar made of iron metal or iron-based metal component to be formed in any shape as required. Being provided on one side of the wheel balancing body is an engaging part fixed thereto. The engaging part is composed of an engaging plate having one end engaged and fixed to one end of the wheel rim engaging bar by a locking means and the other end is bent as an upper curve to be locked and fixed to a wheel rim of an automobile. The wheel rim engaging bar and a part of engaging plate are enwrapped by the outer cover plate made of plastic or plastic-contained composition.

### CROSS REFERENCE TO RELATED APPLICATIONS

This application is a continuation-in-part application of U.S. Application Ser. No. 11/898,684 filed on Sep. 14, 2007 which was based on and claimed priority to Thailand's Patent Application No. 0603001667 filed on Oct. 13, 2006, the entire contents of which are incorporated herein by reference.

### FIELD OF THE INVENTION

The present invention relates to a wheel balancing device, especially a wheel balancing device for an automobile.

### BACKGROUND OF THE INVENTION

In an automobile wheel assembly including a wheel and a tire, a dynamic imbalance may exist when the wheel is rotated. Generally, to compensate for this imbalance, the wheel is provided with a wheel balancing device.

As illustrated in FIGS. 7 and 8, a conventional wheel balancing device includes a wheel balancing body 11 composed of lead which is formed in various shapes which correspond to weight such as 5 grams or 10 grams. A clip including an locking plate 12 having one end being embedded in the wheel balancing body 11 of a wheel balancing device and the other end of the plate 12 is rolled as a curve in upper part 13 which is a long flat plate and some curve part for locking and fixing to a wheel rim of a tire. The top of the upper part curve 13 may be provided with a number of punched holes 14 to be fastened by locking members (not shown).

However, since the material containing the lead has a problem that it can influence the natural environment, the wheel balancing device can be designed with a body made of iron, iron alloy or other materials that are environmentally friendly.

For example, Japanese U.M. No. 3046046 discloses a balancing device comprised of a weight body made of cast iron, and an engaging member made of a steel plate bent and fixed to the weight body by a rivet.

The balancing device disclosed in Japanese U.M. No. 3046046 has a disadvantage that it increases the number of parts and the cost of manufacturing of the balancing device because the engaging member is fixed to the weight body by riveting. Moreover, in case that the weight body is constructed from a hard material such as iron, compressing and flattening a protrusion to result in a rivet is relatively difficult.

Another example, U.S. Pat. No. 6,250,721 discloses a balancing device which includes a weight body made of ductile casting iron and a clip coupled to a groove at a central portion of the weight body. The clip is fitted into the groove by caulking the head of a pillar at a bottom surface of the groove.

On the other hand, the wheel balancing device disclosed in aforesaid U.S. Patent Publication has some defects left such that the clip is coupled to the underside of the weight body; that is, if there are some defects while caulking the cast-iron, which will often cause crack in the metallic ground-boundary, and cause it to break afterwards, sometimes even the clip is hammered to the rim of the wheel, but the weight body will become fairly loose. Also, the manufacturing cost of the weight body increases due to the protruded pillar formed within the groove.

Thus, there exists a need for an improved wheel balancing device, which can reduce the cost problem and can be firmly fixed the clip to the weight body.

### SUMMARY OF THE INVENTION

The purpose of the present invention is made in view of the above mentioned circumstances, and has an object to provide a new and improved wheel balancing device, which is simple to form and low cost and can be securely confirm in fixing between the clip and the weight body.

The wheel balancing device according to the present invention includes a wheel balancing body including a wheel rim engaging iron metal bar or iron-based metal component to be formed in any shape and being provided on one side of the wheel balancing body is an engaging part fixed thereto. The engaging part is composed of engaging plate having one end being engaged with one end of the wheel rim engaging bar by a locking means and the other end is bent as an upper curve to be locked and fixed to a wheel rim of an automobile. The wheel rim engaging bar, having one of the engaging part fixed thereto, is enwrapped by the outer cover plate made of plastic or plastic-contained composition.

The wheel balancing device of this invention is preferably made of iron metal or iron-based metal or other material substitute instead of using lead thereby providing the standpoint of environmental protection. Further, because the wheel balancing body and the engaging part are coupled together by enwrapping such two parts with plastic or plastic-contained composition, forming is easier and lower in cost, also can prevent rust caused by outer moisture and being easily to perform color decoration.

### BRIEF DESCRIPTION OF THE DRAWINGS

The invention will now be described by way of example with reference to the accompanying drawings wherein:

FIG. 1 shows an exploded, perspective view showing the individual parts of the wheel balancing device according to an embodiment of this invention;

FIG. 2 shows a perspective view of an embodiment of the wheel balancing device of this invention when the engaging part is fixed to the wheel balancing body;

FIG. 3 shows a perspective view of another embodiment of the wheel balancing device of this invention when the engaging part is fixed to the wheel balancing body;

FIG. 4 shows an embodiment of the wheel balancing device of this invention having outer cover plastic plate enwrapped thereto;

FIG. 5 shows another embodiment of the wheel balancing device of this invention having outer cover plastic plate enwrapped thereto;

FIG. 6 shows an embodiment of the wheel balancing device of this invention being installed with a wheel rim of an automobile;

FIG. 7 shows a conventional wheel balancing device;

FIG. 8 shows another embodiment of the conventional wheel balancing device.

FIG. 9 shows front, side and top views of the engaging part of the wheel balancing device;

FIG. 10 shows front, side and top views of the wheel rim engaging part;

FIG. 11 shows front, side and top views of when the engaging plate and engaging bar are secured together;

FIG. 12 shows front, side, top and sectional views taken along lines A-A and B-B of the wheel balancing device enwrapped by plastic;

FIG. 13 (A) shows cross-sectional view A-A taken along line A-A of FIG. 12;

FIG. 13 (B) shows cross-sectional view A-A taken along line A-A of FIG. 12 before testing and after testing showing that engaging plate and enwrapped plastic are not damaged; and

FIG. 14 shows the cross sectional view A-A taken along the line A-A of FIG. 12 in the case when only the engaging bar is enwrapped by plastic.

### DETAILED DESCRIPTION OF THE INVENTION

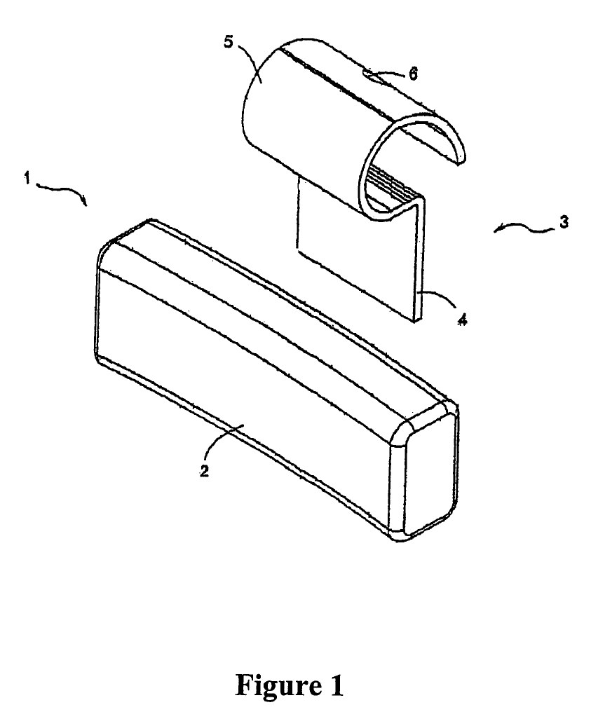

According to FIG. 1, it shows a wheel balancing device comprising a wheel balancing body 1 and an engaging part 3. The wheel balancing body 1 composes of a wheel rim engaging bar 2 made of iron metal or iron-based metal component which is formed in various shape with appropriate weight as required, for instance, 5 grams or 10 grams etc.

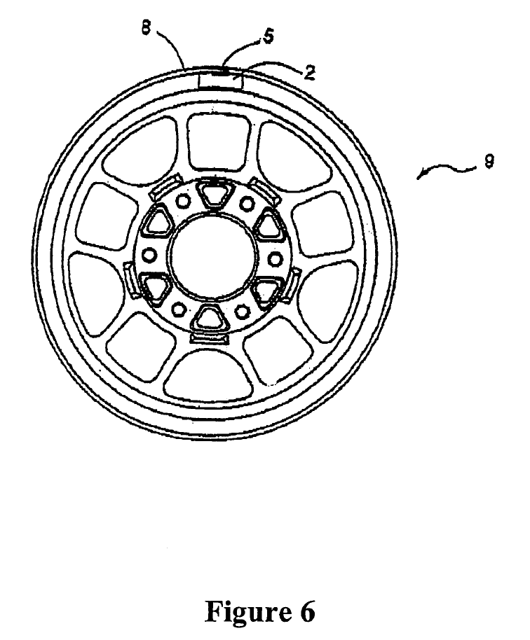

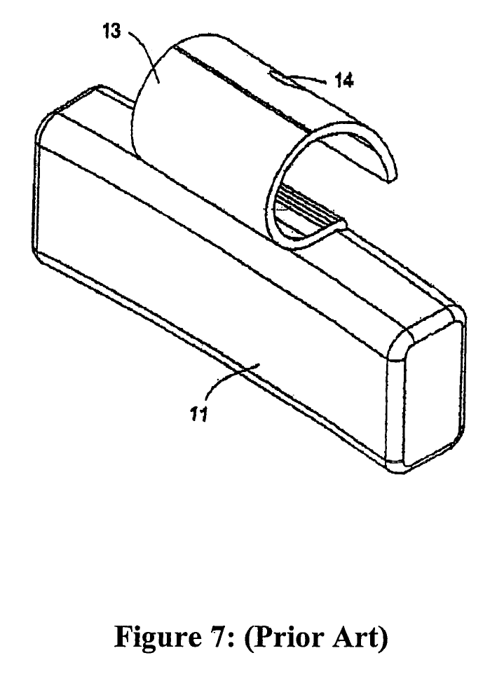

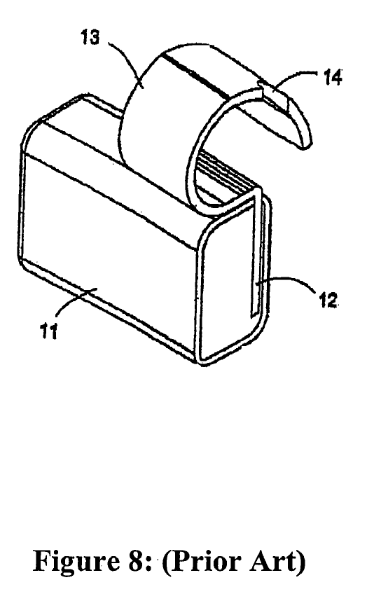

The engaging part 3 comprises an engaging plate 4 having one end being provided for engaging and fixing to one end of the wheel rim engaging bar 2 of the wheel balancing body 1 and the other end is bent into the form of an upper curve 5, in which the curve can be locked and fixed to a wheel rim of an automobile (as illustrated in FIG. 6). The engaging part 3 may be provided, on the upper curve 5, with a number of punched holes 6 to fasten and support the engaging member inserted thereto (not shown in Figures).

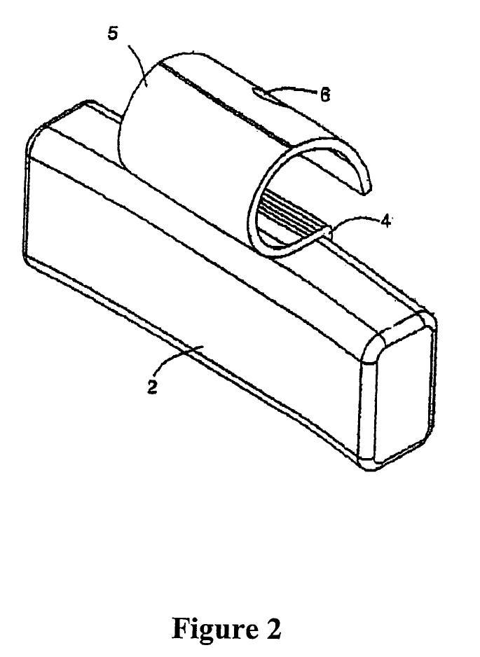

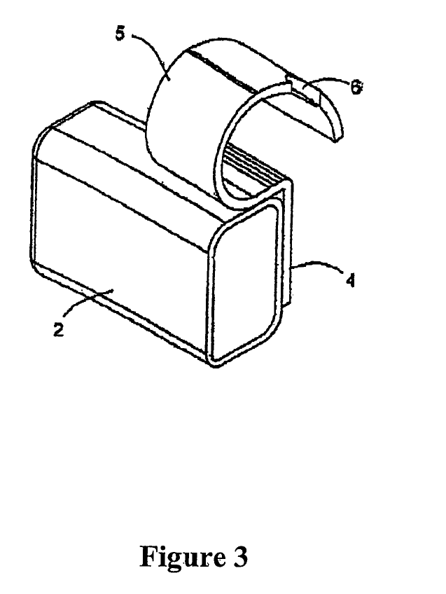

According to FIG. 2, the engaging part 3 is mounted to the wheel balancing body 1 wherein one end of the engaging plate 4 is overlapped and fixed to one side of the wheel rim engaging bar 2 (substantially shown in FIG. 3) by a locking means, thereby defining the wheel balancing device.

FIG. 3 shows the another embodiment of the engaging part 3 mounted to the wheel balancing body 1 wherein one end of the engaging plate 4 being overlapped and fixed to one side of the wheel rim engaging bar 2 by a locking means, thereby defining the wheel balancing device.

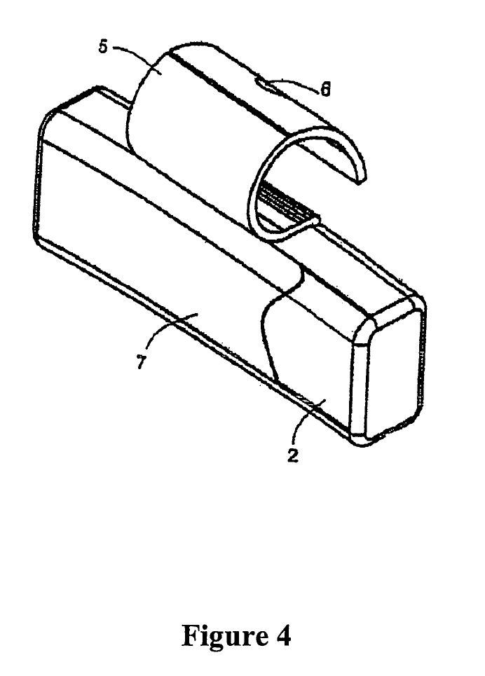

According to FIG. 4, the wheel balancing device composed of the wheel balancing body 1 and the engaging part 3 is then enwrapped by the outer cover plate 7. The outer cover plate 7 made of plastic as a main composition and enwraps the wheel rim engaging bar 2 and some part or the whole part of the engaging plate 4 through any coating means. For instance, by dipping the body, which has the engaging part, at one end into a crucible containing plastic material or plastic composition, or coating such device with plastic or plastic-contained composition by injection into the mold; preferably, the plastic enwrapping should be performed by conventional injection molding method and use heat stabilized Polyamide (PA) 66 resin as enwrapping material. The thickness of enwrapping layer is in the range of between 1-10 mm, preferably at the range of 3-5 mm. As the method described above, the operation of fixing the wheel balancing body 1 to the engaging part 3 can be performed without any requirement of additional engaging parts. Therefore, the manufacturing cost of the wheel balancing device of this invention will be lower, also the moisture and scratch from outside can be avoided.

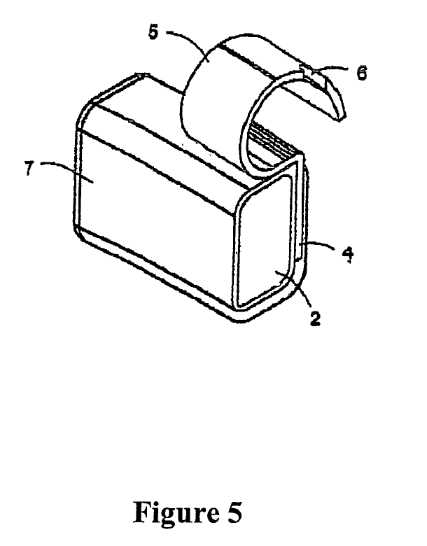

FIG. 5 shows another embodiment of the wheel balancing device of this invention. The wheel balancing device comprises the outer cover plate, in which the wheel rim engaging bar 2 and some part or the whole part of the engaging plate 4 are enwrapped by the outer cover plate 7 in order to hold the engaging plate 4 and the wheel rim engaging bar 2 together and prevent the wheel balancing device from the moisture and any damages.

According to FIG. 6, the wheel balancing device of this invention is mounted to the wheel rim of an automobile by a mounting process. The process comprises the steps, in which the upper curve 5 is attached and fixed to the outer wheel rim 8 of the wheel 9 wherein the wheel rim engaging bar 2 will engage and fix to the lower part of the outer wheel rim 8 of the wheel 9 in order to balance the wheel 9 during moving of the automobile.

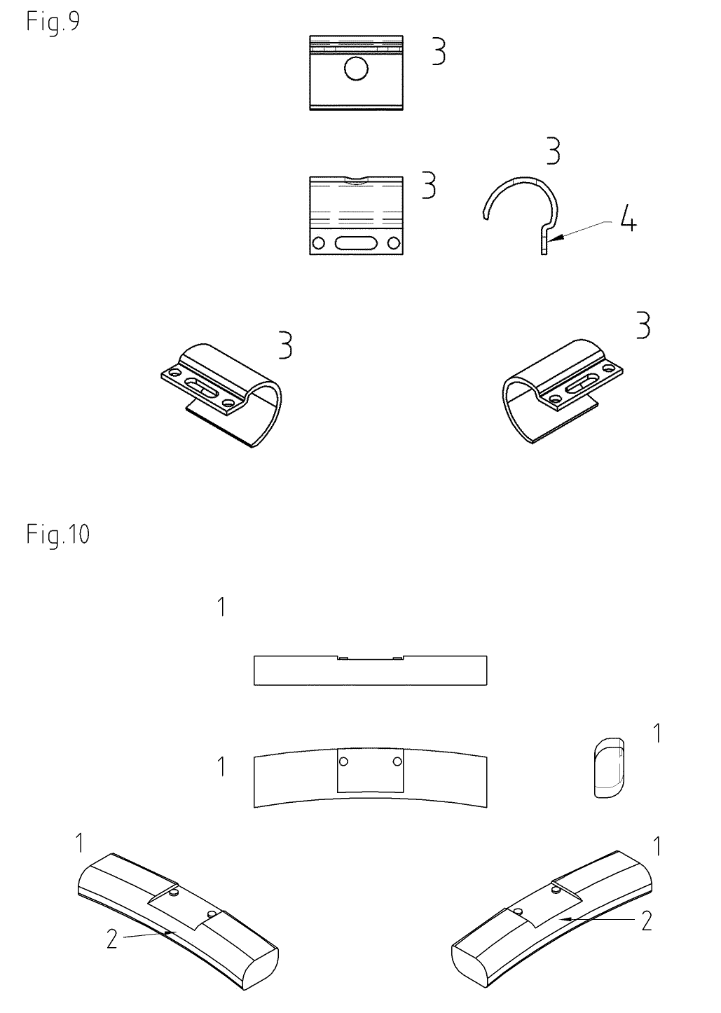

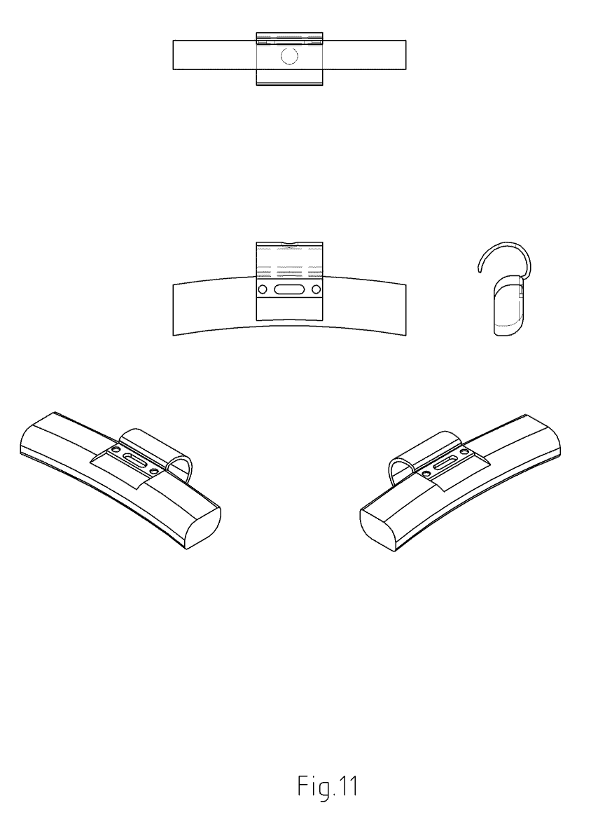

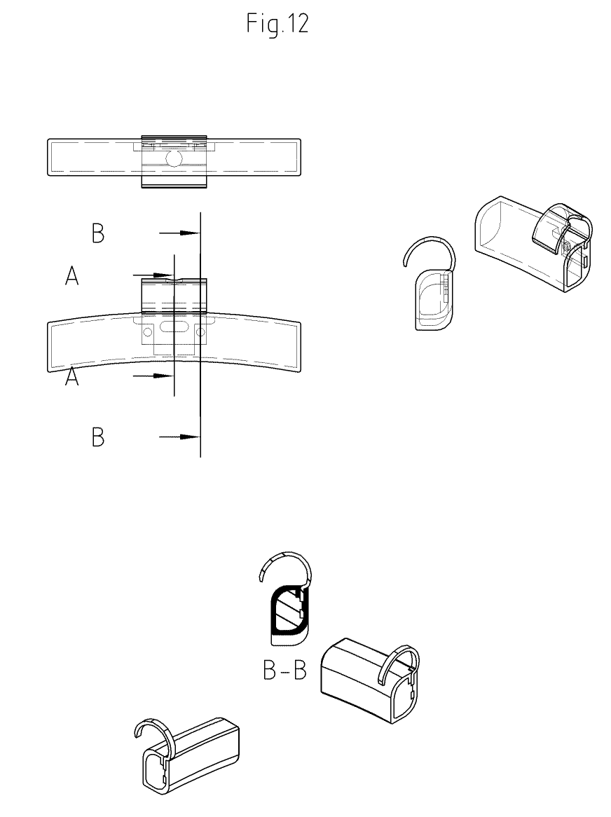

FIG. 9 shows front, side and top views of the engaging part 3 having engaging plate 4 of the wheel balancing device 1. FIG. 10 shows front, side and top views of the wheel rim engaging part 2. FIG. 11 shows front, side and top views of when the engaging plate 4 and engaging bar 2 are secured together. FIG. 12 shows front, side, top and sectional views taken along lines A-A and B-B of the wheel balancing device 1 enwrapped by plastic.

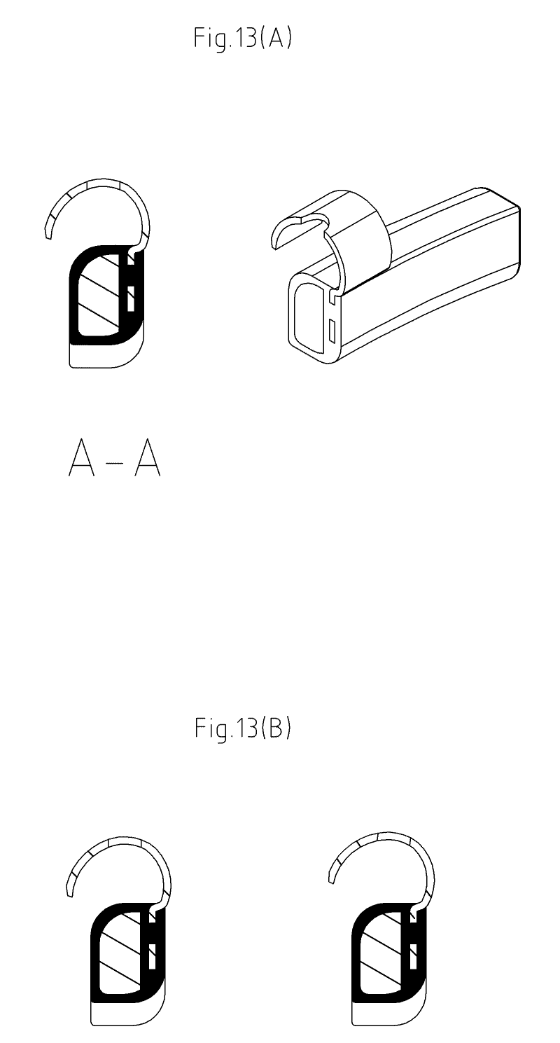

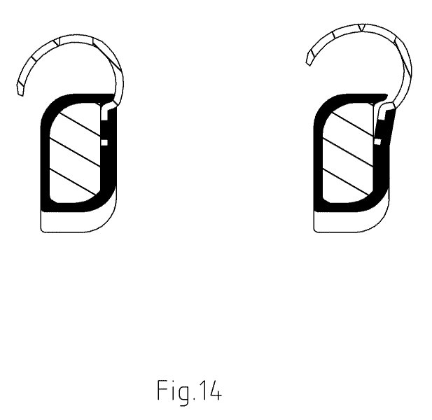

Another embodiment of the invention is illustrated in FIG. 13 (A) showing cross-sectional view A-A of the wheel balancing device 1 taken along line A-A of FIG. 12. As illustrated in FIG. 13(A), the two regions shown as point 1 (region 1) and point 2 (region 2) are controlled in the production such that the thickness of the enwrapped plastic in the region 1 of the wheel balancing device is in the range of 1.2 mm to 8 mm. Also, apart from the minimum specified plastic thickness of 1.2 mm, the plastic should also be injected not only in outer area around the engaging bar 2 but also in between the clip and the bar with sufficient plastic amount inside the clip hole. In other words, the sufficient amount of plastic molding should be injected in between the area where the engaging plate 4 couples together with the engaging bar 2. This prevents the clip from tearing from the bar during mounting of the weight on the rim and also it prevents from being pulled up from the weight body from the top. Also, the region 2 includes the area under the engaging plate as illustrated in FIGS. 13 (A) and (B).

FIG. 13 (B) shows cross-sectional view A-A taken along line A-A of FIG. 12 before testing and after testing showing that engaging plate 4 and enwrapped plastic are not damaged. Also, the results showed that the wheeling balancing device I was stable and did not damage during performance of tension test while adhering to the wheel rim. The inventor found that above constitution showed the significant improvement over the wheel balancing device in which only the engaging bar 2 is enwrapped by plastic injection molding as illustrated in FIG. 14.

Also, the inventors found that when the enwrapped plastic was less than 1.2 mm the engaging plate 4 shifted and the enwrapped plastic was torn as illustrated in FIG. 14. Also, the inventor found that plastic cover should not be more than 8 mm thickness because it adds to the weight of the wheel balancing device 1.

Therefore, when the wheel balancing device 1 was injected by plastic in the outer area around the engaging bar 2, and more to the point in the area where the engaging plate 4 faced the engaging bar 2 where the same plastic connects both sides through the clip center hole, the results showed significant improvement and were unexpectedly good.

### EFFECTS OF THE INVENTION

According to the wheel balancing device according to the present invention, there can be obtained the following advantages:
a) the device is preferable for environmental protection because lead having toxicity to the human body is not used;
b) since the wheel balancing body and the engaging part is fixed together by enwrapping of covering plastic plate, the number and complexity of the operations required to attach the engaging part to the body is reduced which subsequently, reduces the cost of the tooling;
c) the outer covering plastic plate gives an advantage in that the engaging plate is fixed to the wheel rim engaging bar tightly and protects the wheel balancing device from moisture so that rust and any damages can be avoided;
d) at the same time, Logo, model numbers and sizes could be marked on the products together during the plastic injection process. This reduces additional cost of process and Logo tooling;
e) the color coating and aesthetic decoration can perform at the same time as enwrapping plastic plate to fix the wheel balancing body with the engaging part, as a result the cost of manufacturing can be further reduced.

What is claimed is:

1. A wheel balancing device comprising:
a wheel balancing body including a wheel rim engaging bar; and
an engaging part comprising an engaging plate having one end fixed to the wheel rim engaging bar of the wheel balancing body and the other end is bent into a upper curve part to lock and fix to an outer wheel rim of an automobile wheel;
the engaging plate and the wheel rim engaging bar are secured to provide the wheel balancing device,
wherein the engaging plate and the wheel rim engaging bar are secured by means of enwrapping the outer area around the engaging bar and enwrapping the area in between where the engaging plate couples together with the engaging bar by a cover plate in which the cover plate is made of plastic or plastic containing composition.

2. The wheel balancing device as in claim 1, wherein the thickness of plastic or plastic-contained composition enwrapping the outer area around the engaging bar is in the range of 1.2-8 mm.

3. The wheel balancing device as in claim 1, wherein the thickness of plastic or plastic-contained composition enwrapping the outer area around the engaging bar is 1.2 mm.

4. The wheel balancing device as in claim 1, wherein the thickness of plastic or plastic-contained composition enwrapped in between the engaging plate and the engaging bar is not less than 1.2-8 mm.

5. The wheel balancing device as in claim 1, wherein the thickness of plastic or plastic-contained composition enwrapped in between the engaging plate and the engaging bar is 1.2 mm.

6. The wheel balancing device as in claim 1, wherein the thickness of plastic or plastic-contained composition enwrapping the outer area around the engaging bar and in between the engaging plate and the engaging bar is not less than 1.2-8 mm.

7. The wheel balancing device as in claim 1, wherein the thickness of plastic or plastic-contained composition enwrapping the outer area around the engaging bar and in between the engaging plate and the engaging bar is 1.2 mm.

8. A wheel balancing device comprising:
a wheel balancing body including a wheel rim engaging bar; and
an engaging part comprising an engaging plate having one end fixed to the wheel rim engaging bar of the wheel balancing body and the other end is bent into a upper curve part to lock and fix to an outer wheel rim of an automobile wheel;
the engaging plate and the wheel rim engaging bar are secured to provide the wheel balancing device,
wherein the two parts are coupled together by means of enwrapping them by an outer cover plate, in which the outer cover plate is made of plastic or plastic containing composition.

9. The wheel balancing device as in claim 1, having a part of the engaging plate overlapped and fixed to one side of the wheel rim engaging bar of the wheel balancing body.

10. The wheel balancing device as in claim 1, wherein the wheel balancing body having the engaging part fixed at one end is enwrapped by plastic or plastic-contained composition by means of injection molding.

11. The wheel balancing device as in claim 1, wherein the thickness of plastic or plastic-contained composition enwrapped on the wheel balancing device is in the range of 1-10 mm.

12. The wheel balancing device as in claim 1, wherein the thickness of plastic or plastic-contained composition enwrapped on the wheel balancing device is in the range of 3-5 mm.

13. The wheel balancing device as in claim 2, wherein the wheel balancing body having the engaging part fixed at one end is enwrapped by plastic or plastic-contained composition by means of injection molding.

14. The wheel balancing device as in claim 2, wherein the thickness of plastic or plastic-contained composition enwrapped on the wheel balancing device is in the range of 1-10 mm.

15. The wheel balancing device as in claim 3, wherein the thickness of plastic or plastic-contained composition enwrapped on the wheel balancing device is in the range of 1-10 mm.

16. The wheel balancing device as in claim 2, wherein the thickness of plastic or plastic-contained composition enwrapped on the wheel balancing device is in the range of 3-5 mm.

17. The wheel balancing device as in claim 3, wherein the thickness of plastic or plastic-contained composition enwrapped on the wheel balancing device is in the range of 3-5 mm.

18. The wheel balancing device as in claim 4, wherein the thickness of plastic or plastic-contained composition enwrapped on the wheel balancing device is in the range of 3-5 mm.
